(19) United States
(12) Patent Application Publication
(10) Pub. No.: US 2011/0078686 A1
(43) Pub. Date: Mar. 31, 2011

(54) METHODS AND SYSTEMS FOR HIGHLY AVAILABLE COORDINATED TRANSACTION PROCESSING

(75) Inventors: Arun K. Iyengar, Yorktown Heights, NY (US); Gong Su, New York, NY (US); Yanqi Wang, Beijing (CN); Yu Yuan, Beijing (CN); Jia Zou, Beijing (CN)

(73) Assignee: International Business Machines Corporation, Armonk, NY (US)

(21) Appl. No.: 12/567,889

(22) Filed: Sep. 28, 2009

(51) Int. Cl. G06F 9/46

(52) U.S. Cl. 718/101

(57) ABSTRACT

Embodiments of the invention provide a coordinated transaction processing system capable of providing primary-primary high availability as well as minimal response time to queries via utilization of a virtual reply system between partner nodes. One or more global queues ensure peer nodes are synchronized.

### BACKGROUND

Coordinated transactions (multi-leg transactions/trading, for example multi-leg stock trading) allow submission of multiple transaction requests (for example multiple stock trading requests) in a consolidated order, which will be executed atomically as a single transaction. One example of 2-leg transaction request (order) is to “buy 200 shares of stock A” AND “sell 300 shares of stock B”, which can get executed if and only if both orders can get executed.

Multi-leg trading offers considerably more flexibility over what one would get with conventional stock trading (single-leg trading). However, implementing multi-leg transaction processing (trading) efficiently in an electronic environment is difficult.

### BRIEF SUMMARY

Embodiments of the invention provide a coordinated transaction processing system capable of providing primary-primary high availability via utilization of redundant peer nodes as well as minimal response time to queries via utilization of a messaging system between partner nodes. Embodiments of the invention ensure that peer nodes within a transaction processing system give consistent replies for the same multi-leg query. Embodiments of the invention provide that the multi-leg transactions and corresponding queries are inserted into a total ordered (global) queue so that peer nodes within the transaction processing system ascertain the same query in the same context and then give consistent replies for the query.

Various embodiments of the invention supply information necessary for generating messages which avoid deadlock situations been nodes of a transaction processing system. The messages can include, for example, “virtual replies” generated from queries so that when partner nodes within the transaction processing system are querying each other simultaneously, they will get virtual replies immediately instead of waiting for the queries to be processed and actual replies issued. In certain cases, embodiments of the invention provide virtual replies which reduce round-trip communication (query and reply) to a simplified one-way communication (query only). Accordingly, embodiments of the invention provide primary-primary high-availability for multi-leg trading such that a node failure will not disrupt the entire transaction processing system as well as ensuring that communication overhead from multi-leg trading is reduced.

In summary, one aspect of the invention provides an apparatus comprising: one or more processors; one or more computer readable storage mediums having computer readable program code embodied therewith, the computer readable program code being executable by the one or more processors and comprising: computer readable program code configured to synchronize transaction processing order among the apparatus and one or more peer nodes of a transaction processing system through a shared memory; and computer readable program code configured to issue one or more queries from the apparatus to one or more partner nodes within the transaction processing system; the one or more queries being configured to ascertain if the one or more partner nodes can process one or more transactions corresponding to the one or more queries.

Another aspect of the invention provides a method comprising:

issuing one or more queries from a first electronic device to one or more partner electronic devices within a multi-leg transaction processing system; the one or more queries being configured to ascertain if the one or more partner electronic devices can process one or more transactions corresponding to the one or more queries; and the one or more queries being further configured to enable the one or more partner electronic devices to generate an indication of one or more available transactions at the first electronic device.

A further aspect of the invention provides, in a system comprised of a plurality of nodes in which the plurality of nodes have shared memory to communicate with, a method for processing transactions comprising the steps of: receiving a plurality of transactions in a different order at two or more nodes of said plurality of nodes; receiving one or more messages from one or more other nodes of said plurality of nodes at said two or more nodes of said plurality of nodes, wherein the one or more messages results from processing one or more transactions via the one or more other nodes of the plurality of nodes; and using the shared memory by the two or more nodes of said plurality of nodes to determine a mutually agreeable order for handling said plurality of transactions and said one or more messages.

A still further aspect of the invention provides a computer program product comprising a computer readable storage medium having computer readable program code embodied therewith, the computer readable program code comprising: computer readable program code configured to issue one or more queries from a first node to one or more partner nodes within a multi-leg transaction processing system; the one or more queries being configured to ascertain if the one or more partner nodes can process one or more transactions corresponding to the one or more queries; and the one or more queries being further configured to enable the one or more partner nodes to generate an indication of one or more available transactions at the first node.

For a better understanding of embodiments of the present invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system according to an embodiment of the invention.

FIG. 2 illustrates an overall architecture of a multi-leg transaction processing system according to an embodiment of the invention.

FIG. 3 illustrates partner nodes according to an embodiment of the invention.

FIG. 4 illustrates thread processing (Thread A in FIG. 3) for a node within a multi-leg transaction processing system according to an embodiment of the invention.

FIG. 5 illustrates thread processing (Thread B in FIG. 3) for a node within a multi-leg transaction processing system according to an embodiment of the invention.

FIG. 6 illustrates peer node synchronization according to an embodiment of the invention.

FIG. 7 illustrates partner node deadlock avoidance according to an embodiment of the invention.

### DETAILED DESCRIPTION

It will be readily understood that the components of the embodiments of the invention, as generally described and illustrated in the figures herein, may be arranged and designed in a wide variety of different configurations in addition to the described presently preferred embodiments. Thus, the following more detailed description of the embodiments of the invention, as represented in the figures, is not intended to limit the scope of the claims but is merely representative of selected presently preferred embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the figures/drawings. The following description is intended only by way of example, and simply illustrates certain selected presently preferred embodiments of the invention as claimed herein.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that although this disclosure in large part focuses on discussion of embodiments of the invention as implemented in the context of electronic stock trading involving multi-leg transactions, various embodiments of the invention are applicable to a wide variety of contexts involving multi-leg transaction processing (coordinated transaction processing), including but not limited to publish/subscribe systems, online auctions, on-line stores generally and the like. Moreover, throughout this disclosure, embodiments of the invention are described using stock trades; however, the stock trades are used herein as non-limiting examples of transaction types that may be processed by embodiments of the invention. Other transaction types may be processed by embodiments of the invention as well, such as commodities, options and the like.

The inventors have recognized that a key problem with implementing multi-leg transaction processing is how to maintain high availability because high availability is a strict and mandatory requirement of all stock exchanges. Typically a stock trading system contains many execution venues (EV). Multiple EVs that are redundant and process the same stock symbol(s) (or for example the same stock types) for the sake of high-availability will be referred to herein as peer EVs. Multiple EVs processing multiple legs of a multi-leg order respectively will be referred to herein as partner EVs.

It should be understood that in single-leg trading, there are two existing high-availability (HA) paradigms for peer EVs: primary-secondary (also known as hot back-up) and primary-primary. Most stock exchanges only support primary-secondary high availability paradigm, while primary-primary is a more promising paradigm due to its significantly lower fail-over time. A primary-primary paradigm for single-leg trading that can be extended to multi-leg trading has been proposed, however, the inventors have recognized that at least two more challenges must be addressed for implementation to be optimal. First, peer EVs should give consistent replies for the same multi-leg query; and second, partner EVs should avoid deadlock situations, particularly when querying one another directly.

Accordingly, embodiments of the invention provide methods and systems to address these challenges and provide a complete solution for implementing multi-leg trading with high availability, including primary-primary high availability, in an electronic coordinated transaction processing system.

A presently preferred embodiment of the invention provides primary-primary high-availability for multi-leg trading such that a node (EV) failure will not disrupt the entire transaction processing system as well as ensures that communication overhead from multi-leg trading is reduced. In certain cases, embodiments of the invention provide messages such as “virtual replies” which reduce round-trip communication (query and reply) to a simplified one-way communication (query only).

The inventors have recognized that a first challenge is presented by the fact that peer EVs may be processing different orders (that is have different contexts) when they receive a multi-leg query from a partner EV. However, they must give consistent replies to the query so that the redundant nature of the peer EVs will not be broken. Moreover, the inventors have recognized that partner EVs may send queries to each other simultaneously. If the partners all keep waiting for the replies to their own queries and do not response the received queries, they will come to a deadlock. Accordingly, embodiments of the invention, among other advantages, provide solutions to these challenges.

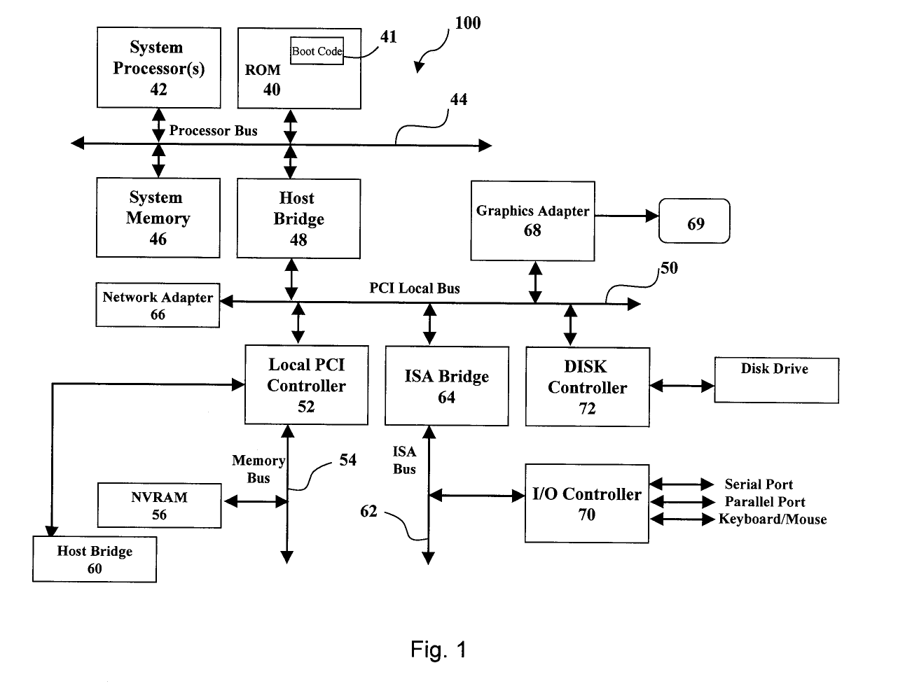

Referring now to FIG. 1, there is depicted a block diagram of an illustrative embodiment of a computer system 100. The illustrative embodiment depicted in FIG. 1 may be an electronic device such as desktop, laptop, workstation, mobile computer, mobile Internet device, smart phone and the like. As is apparent from the description, however, the embodiments of the invention may be implemented in any appropriately configured electronic device, as described herein.

As shown in FIG. 1, computer system 100 includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces electronic device 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, and the like. A disk controller 72 connects a disk drive with PCI local bus 50. The USB Bus and USB Controller (not shown) are part of the Local PCI controller (52).

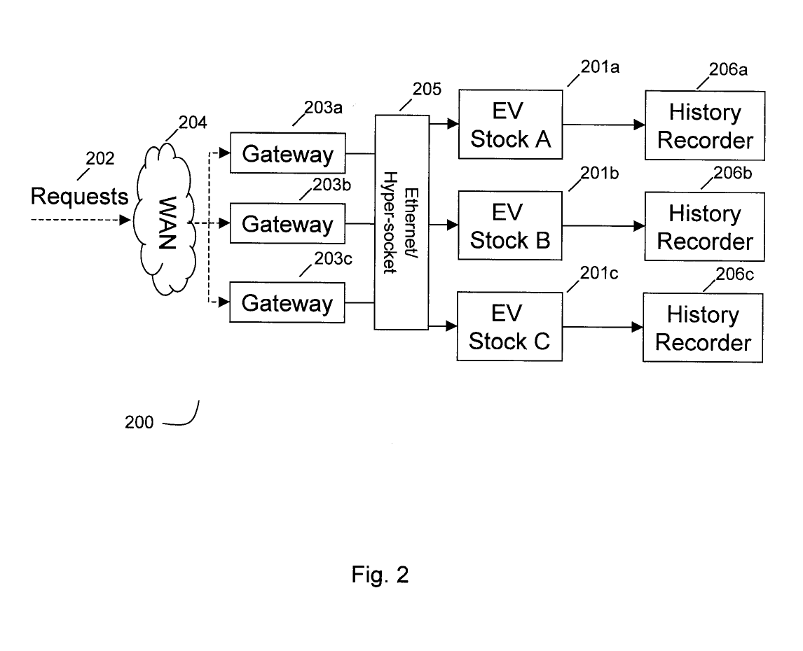

FIG. 2 illustrates a transaction processing system according to one embodiment of the invention. As shown the illustrative transacting processing system 200 includes a plurality of Exchange Venues (EVs 201a, 201b, and 201c) wherein each EV processes one stock symbol (A, B, C) (or stock type, transaction type, et cetera). A transaction processing system 200 according to embodiments of the invention may be implemented using a computer system, such as computer system 100. Requests 202 (for example buy/sell requests/orders) are received via one or more gateways 203a, 203b, 203c, et cetera, via a suitable connection, for example WAN 204. The gateways 203a, 203b, 203c process and forward the requests 202 to the appropriate EV via a suitable connection, for example Ethernet/Hyper-socket 205. The EVs forward information regarding the transaction legs' processing to one or more history recorders 206a, 206b, 206c et cetera.

In the context of electronic stock trading, utilized for illustrating certain embodiments of the invention, the following trading policies should be observed. For single-leg orders: a) among all orders that have been received but not traded by an EV, an order that offers a better price should get traded earlier than other orders; and, b) for orders offering the same price, the order that comes earlier should get traded earlier than other orders. For multi-leg orders: a) among all orders that have been received but not traded by an EV, an order that offers a better price should get its reply received earlier than other orders; and, b) for orders offering the same price, the order that comes earlier should get its reply received earlier than other orders.

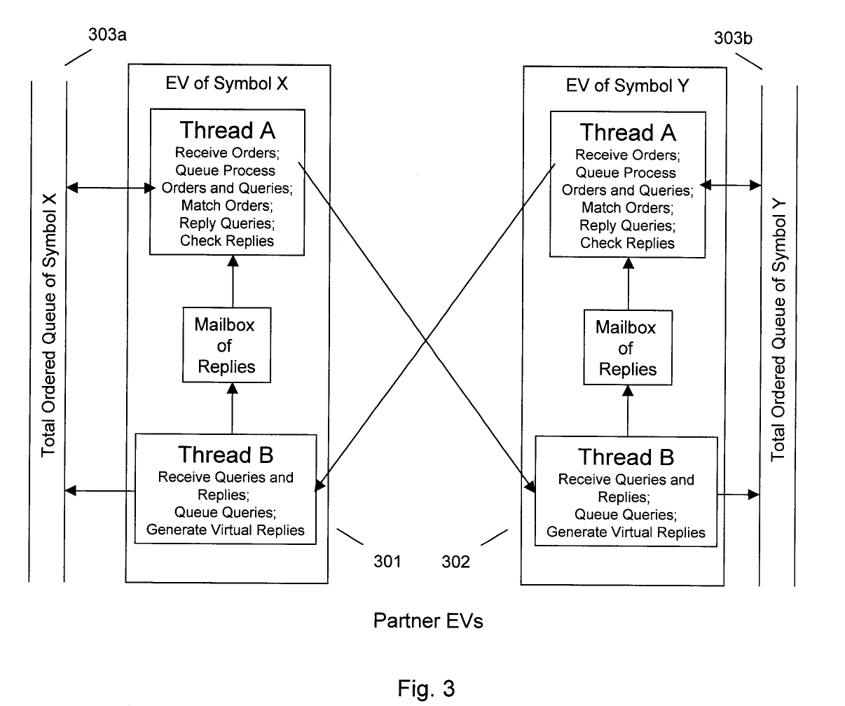

FIG. 3 illustrates a pair of partner EVs (handling different stock symbols or stock types, X and Y in this non-limiting example) according to one embodiment of the invention. Peer EVs are not shown here for simplicity sake and will be described further herein (peer EVs preferably follow the primary-primary high availability paradigm and use a total ordered queue 303a, 303b to determine the sequence of orders to be processed).

It should be understood generally that Thread A of a first EV, when issuing a query (for example a query to a partner EV Thread B regarding a multi-leg transaction), enables Thread B of the partner EV to generate a message (for example, a “virtual reply”), which is an indication (useable by Thread A of the partner EV) of the available, related transactions at the first EV (that issued the query). The partner EV can also issue a message (for example, an actual reply) to the query received in addition to the virtual reply it generates for itself, as discussed further herein.

To address the challenges involved by multi-leg trading described herein, EVs according to an embodiment of the invention work as follows:
Each EV has two threads (A and B herein) that take charge of different tasks;
Thread A receives orders from gateways (for example 203a, 203b and 203c) and queues orders into the total ordered queue 303a, 303b;
Thread B receives queries and replies from partner EVs;
For every reply from partner EVs, Thread B will put the reply into the mailbox of replies;
For every query from partner EVs, Thread B will queue the query into the total ordered queue. At the same time, Thread B will generate a corresponding message, a virtual reply, and put the virtual reply into the mailbox of replies. For example, if the query is “(x₁, y₁) is a multi-leg order, y₁ is doable on EV Y, is x₁ doable on EV X?”, the corresponding virtual reply is “y₁ is doable on EV Y”;
Thread A will check the mailbox only after it sends out a query;
Mailboxes cannot be overwritten. If a mailbox is full, and Thread B is receiving a reply or generating a new virtual reply, Thread B will wait until the mailbox is not full again and then write the reply into the mailbox;
If a reply is not about the query that has just been sent out by Thread A,

Thread A will regard the reply as a “not doable”. For example, Thread A of EV X sends out a query about the order y₁, and then checks the mailbox. If it gets a reply about the order y₂ instead of y₁, it will regard y₁ as “not doable on EV Y”;
When Thread A is processing a query, it will check if the corresponding virtual reply of this query is still in the mailbox. If the virtual reply is there, Thread A will discard the virtual reply and then process the query. If the virtual reply is not there, Thread A will discard the query. In this way, when two partner EVs are taking virtual replies from each other, the queries that generate the virtual replies will not be processed since they are useless.
Thread B will maintain a sequence number watch for each partner symbol. If Thread B receives a query or a reply whose sequence number is not greater than the corresponding sequence number watch, the query or the reply will be regarded as redundant (from slow peers of the partner EV) and then discarded.

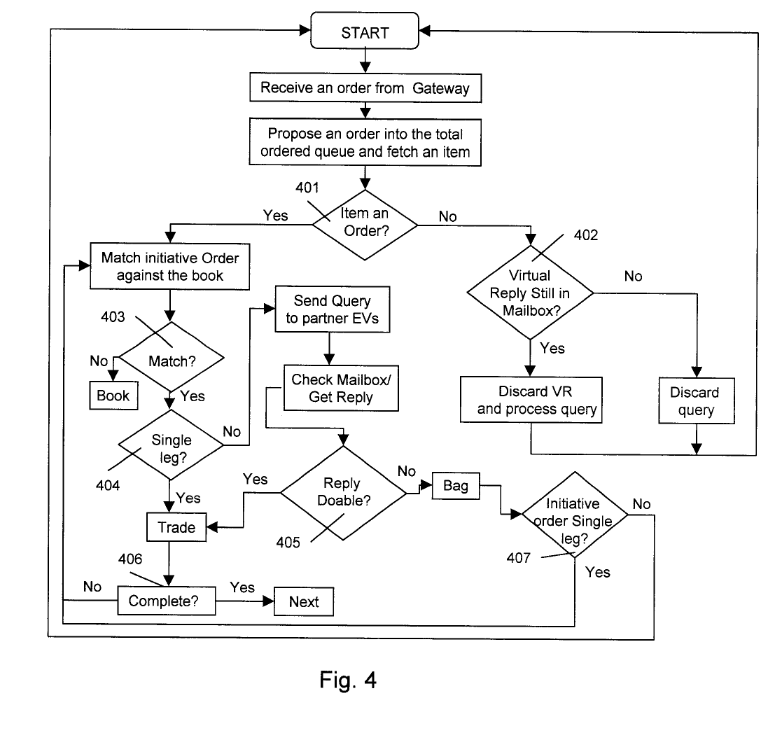

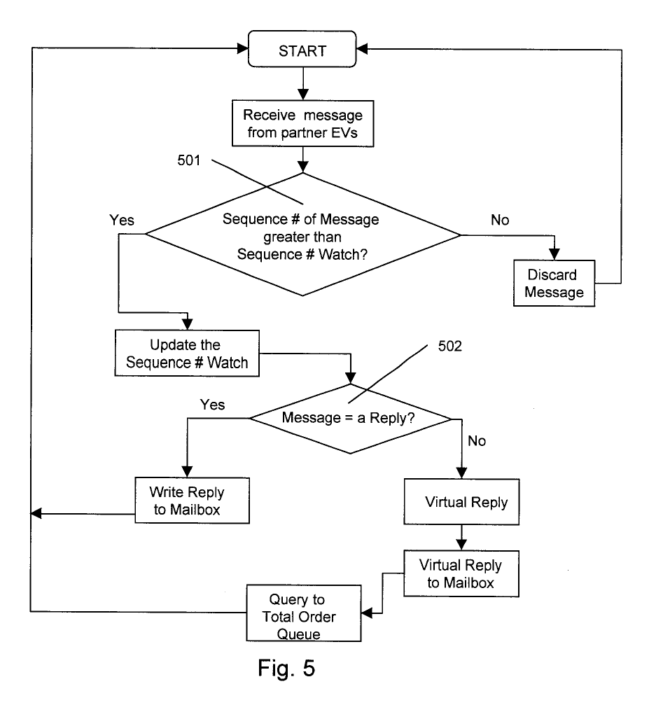

FIGS. 4-5 illustrate flowcharts of thread processing according to embodiments of the invention. FIG. 4 illustrates a flow chart of Thread A (FIG. 3). FIG. 5 illustrates a flow chart of Thread B (FIG. 3). Each flow chart will be discussed in turn.

Referring to FIG. 4, Thread A (for example, Thread A of EV_{X}) processing is illustrated according to an embodiment of the invention. The processing starts with a received order from a gateway. The order, which may be single-leg or multi-leg, is proposed to the total ordered (global) queue and an item (an order or a query from a partner EV) is fetched from the total ordered (global) queue. At 401, it is determined if the item fetched is an order (for example an order for buying a stock) or a query (for example, a query from another EV asking about an order it is handling that may be partially executed on the current EV). If the item fetched from the total ordered (global) queue is an order, it will proceed through the left side of the flow; whereas if the fetched item from the total ordered (global) queue is a query, it will proceed to through the right side of the flow in FIG. 4.

If the item is determined not to be an order, it is determined to be a query (for example, can stock X sell in EV_{X}?). Subsequently, it is determined if the virtual reply corresponding to this query (for example, stock Y can buy in EV_{Y}) is still in the mailbox at 402. If the virtual reply (stock Y can buy in EV_{Y}) is not in the mailbox, the query (for example, can stock X sell?) is discarded. This is because the virtual reply (stock Y can buy in EV_{Y}) was already utilized (and therefore cleared) by EV_{X}, thus the query (can stock X sell?) will no longer be a valid query. This is because a virtual reply R_{Y-to-X} is used only when a query Q_{X-to-Y} initialized from the EV_{X} is waiting for a reply from the EV_{Y}. So this query Q_{X-to-Y} must have been sent to the partner EV_{Y} and generated another virtual reply R_{X-to-Y} on the partner EV_{Y}. Then, the query Q_{Y-to-X} that generates the virtual reply R_{Y-to-X} is no longer needed to be replied since we already have a virtual reply R_{X-to-Y}.

If it is determined at 402 that the virtual reply (stock Y can buy in EV_{Y}) is still in the mailbox, the virtual reply (stock Y can buy in EV_{Y}) is discarded and the corresponding query (can stock X sell?) can be processed. In other words, the query (can stock X sell?) finds its own corresponding virtual reply (stock Y can buy in EV_{Y}) if it is available in the mailbox prior to the query (can stock X sell?) being answered by EV_{X}. This processing keeps the peer EVs (for example EV_{X} and EV_{X′}, not shown) synchronized in the primary-primary high availability architecture as it avoids unnecessary and redundant query processing.

If it is determined at 401 that the fetched item is an order, the initiative order (the order that is just fetched from the queue) is matched against the book (of unmatched orders). At 403 it is determined if there is a match for the initiative order in the book. If no match exists, the initiative order is placed in the book and must await an incoming match. However, if a match exists in the book as determined at 403, it is determined if the order involves only single leg order(s) at 404. If the order(s) is/are only single leg, the order is processed. However, if the item is not a limited to single leg order(s) (that is, it involves a multi-leg order), a query is sent to one or more partner EVs (which may be able to complete a leg of the multi-leg transaction and must be queried to determine this). A periodic check of the mailbox is conducted in order to determine when the reply is received.

Once the reply is received, it is determined if the reply is “doable” at 405, for example, it is determined if the reply matches the query issued and contains a positive answer that the queried order can be traded on the partner EV. If the trade is completed, it is determined if the order is completed (partial match is allowed, so here if an order is just partially traded, there would be a remaining part at 406 (also considered as an order). (The term “partial match” means for example, the original order is “buy 200 shares of stock A”, and 150 A shares are bought, then a remaining order is “buy 50 shares of stock A”)). If not, the remaining order cycle back to match the remaining portions of the order against the book, et cetera. However, if the order is completed, the next item can begin processing (fetch next item from the global queue).

If it is determined that the reply is not “doable” at 405 (that is, the reply does not match the query issued), the multi-leg order is placed in the bag. At 407 it is determined if the initiative order is a single leg order. If the initiative order is a single leg order, the process again loops back to match the initiative order against the book (check for new matches that may have arrived in the book or existing orders with worse prices). However, if the initiative order is not a single leg order, the process cycles back to start.

FIG. 5 illustrates Thread B (for the purposes of this discussion, Thread B of EV_{X}) processing according to an embodiment of the invention. Processing starts when a query is received from Thread A of a partner EV. The sequence number of the message is then determined at 501. If the sequence number of the message is greater than the sequence number watch, the sequence number watch is updated and the message is accepted. However, if the sequence number of the message is not greater than the sequence number watch, the message is discarded (as a message from a slower peer and thus redundant).

If the message is accepted, it is determined at 502 if the message is a query (or a reply). If the message is a reply, the reply is written to the mailbox. However, if the message is a query, the corresponding virtual reply is written to the mailbox and the query is queued to the total ordered (global) queue for subsequent processing by Thread A, as discussed herein.

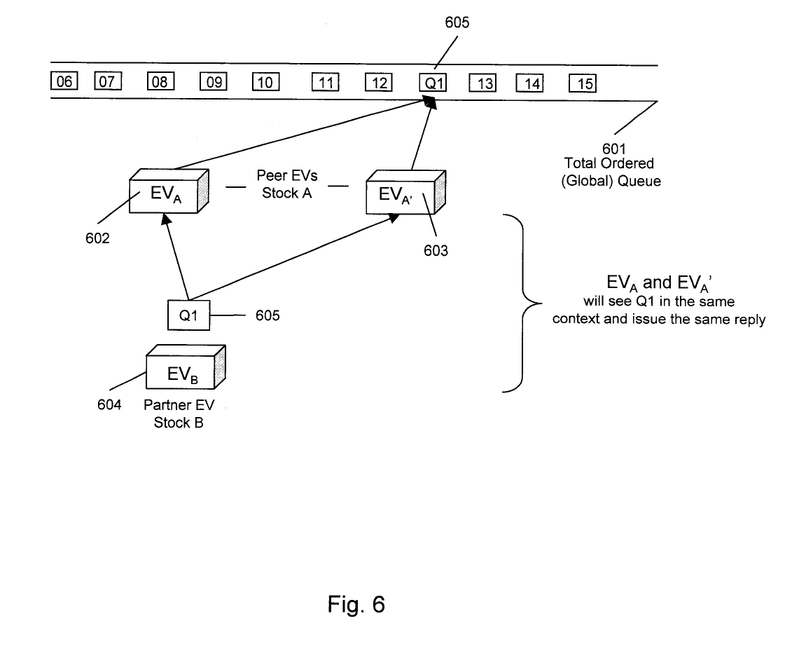

FIG. 6 shows an example according to an embodiment of the invention of how two peer EVs (for example EV_{A} 602 and EV_{A′} 603) give consistent replies to a partner EV (for example, EV_{B} 604) for a query. Since the query Q1 605 is put into the total ordered (global) queue 601 of the peers EV_{A} 602 and EV_{A′} 603 and then will be fetched from the queue 601, both EV_{A} 602 and EV_{A′} 603 will see Q1 605 in the same context so that they will give the same reply. Accordingly, peer EVs will be synchronized in their responses to queries from a partner EV.

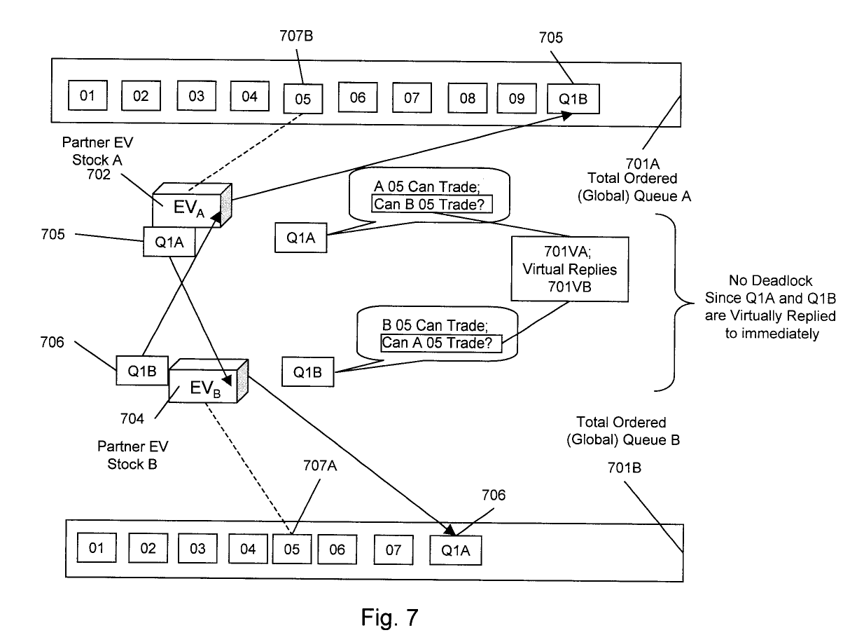

FIG. 7 shows an example according to one embodiment of the invention of how deadlocks are avoided between partner EVs (for example, EV_{A} 702 and EV_{B} 704). Both EV_{A} 702 and EV_{B} 704 will not wait for the real replies to the queries Q1_{A} 705 and Q1_{B} 706, since they can get virtual replies immediately. Thus, the corresponding virtual replies (701A, 701B, written by Thread Bs in response to obtaining the queries) ensure that unnecessary deadlock is avoided, as these virtual replies will enable the partner EVs to process their queries without waiting for the actual response. Later Q1_{A} 705 and Q1_{B} 706 will be discarded (per FIG. 4) from the total ordered (global) queues 701A, 701B when they are fetched, since their corresponding virtual replies (701VA, 701VB) have been eaten (utilized in prior processing by EV_{A} and EV_{B}, respectively).

Again it should be noted that the above examples utilize stocks (for example stocks having particular symbols, related stocks grouped as stock types and the like) to illustrate various aspects of the invention. However, stocks are used herein as non-limiting examples of transaction types that may be processed by embodiments of the invention. Other transaction types may be processed by embodiments of the invention as well, such as commodities, options and the like.

In brief recapitulation, embodiments of the invention broadly contemplate a primary-primary transaction processing system configured to synchronize redundant (peer) nodes via use of total ordered (global) queues and reduce transaction processing delay via utilization of virtual replies, thus avoiding deadlock between partner nodes.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “service,” “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. An apparatus comprising:
one or more processors;
one or more computer readable storage mediums having computer readable program code embodied therewith, the computer readable program code being executable by the one or more processors and comprising:
computer readable program code configured to synchronize transaction processing order among the apparatus and one or more peer nodes of a transaction processing system through a shared memory; and
computer readable program code configured to issue one or more queries from the apparatus to one or more partner nodes within the transaction processing system;
the one or more queries being configured to ascertain if the one or more partner nodes can process one or more transactions corresponding to the one or more queries.

2. The apparatus according to claim 1, wherein the one or more queries are further configured to enable the one or more partner nodes to generate an indication of one or more available transactions.

3. The apparatus according to claim 2, wherein the indication comprises a virtual reply indicating one or more available transactions of the apparatus.

4. The apparatus according to claim 1, wherein the computer readable program code configured to synchronize transaction processing order further comprises:
computer readable program code configured to fetch transaction processing ordering information from and store transaction processing ordering information into the shared memory; and
computer readable program code configured to compare transaction processing ordering information stored locally with that fetched from the shared memory and to determine a globally agreed transaction processing ordering.

5. The apparatus according to claim 1, wherein the transaction processing system comprises a multi-leg transaction processing system.

6. The apparatus according to claim 1, wherein the computer readable program code further comprises:
computer readable program code configured to store one or more messages within one or more mailboxes of the apparatus;
the messages comprising one or more of a reply to a query and a virtual reply generated from a query.

7. The apparatus according to claim 3, wherein the computer readable program code further comprises:
computer readable program code configured to ascertain if one or more virtual replies generated from a query have been cleared from the mailbox prior to processing the query.

8. The apparatus according to claim 1, wherein the computer readable program code further comprises:
computer readable program code configured to:
ascertain if a received order is a single leg or multi-leg order; and
in response to ascertaining the order is a multi-leg order, issue the one or more queries to one or more partner nodes.

9. The apparatus according to claim 2, wherein the one or more available transactions comprise one or more stock transactions.

10. A method comprising:
issuing one or more queries from a first electronic device to one or more partner electronic devices within a multi-leg transaction processing system;
the one or more queries being configured to ascertain if the one or more partner electronic devices can process one or more transactions corresponding to the one or more queries; and
the one or more queries being further configured to enable the one or more partner electronic devices to generate an indication of one or more available transactions at the first electronic device.

11. The method according to claim 10, wherein the indication comprises a virtual reply indicating one or more available transactions at the first electronic device.

12. The method according to claim 10, wherein the multi-leg transaction processing system handles multiple stock types in different exchange venues.

13. The method according to claim 10, further comprising utilizing a shared memory to synchronize a plurality of peer nodes of the multi-leg transaction processing system.

14. The method according to claim 10, further comprising:
receiving a query at the first electronic device from the one or more partner electronic devices;
generating a virtual reply at the first electronic device in response to the query; and
storing the virtual reply in a mailbox of the first electronic device.

15. The method according to claim 14, further comprising:
ascertaining the virtual reply has been cleared from the mailbox prior to processing the query received from the one or more partner electronic devices.

16. The method according to claim 10, further comprising:
ascertaining if a received order is a single leg or multi-leg order;
wherein in response to ascertaining the order is a multi-leg order, issuing the one or more queries to one or more partner electronic devices.

17. The method according to claim 10, wherein the one or more available transactions comprise one or more available stock transactions.

18. The method according to claim 10, wherein the one or more queries being configured to ascertain if the one or more partner electronic devices can process one or more transactions corresponding to the one or more queries are further configured to ascertain if the one or more partner electronic devices can process one or more stock transactions.

19. The method according to claim 10, further comprising:
processing items comprising orders and queries in an ordered fashion from a global transaction processing queue;
wherein the global transaction processing queue comprises a global queue accessible to the first electronic device and one or more peer electronic devices within the multi-leg transaction processing system.

20. The method according to claim 10, wherein the first electronic device comprises a first execution venue responsible for trading a first stock type; and
wherein the one or more partner electronic devices comprise one or more other execution venues responsible for trading one or more other stock types.

21. In a system comprised of a plurality of nodes in which the plurality of nodes have shared memory to communicate with, a method for processing transactions comprising the steps of:
receiving a plurality of transactions in a different order at two or more nodes of said plurality of nodes;
receiving one or more messages from one or more other nodes of said plurality of nodes at said two or more nodes of said plurality of nodes, wherein the one or more messages results from processing one or more transactions via the one or more other nodes of the plurality of nodes; and
using the shared memory by the two or more nodes of said plurality of nodes to determine a mutually agreeable order for handling said plurality of transactions and said one or more messages.

22. The method according to claim 21, wherein said shared memory comprises a global transaction queue of a multi-leg transaction processing system.

23. The method according to claim 21, wherein the plurality of transactions comprise one or more of stock buy orders and stock sell orders.

24. The method according to claim 21, wherein the two or more nodes comprise peer nodes of a primary-primary high availability multi-leg transaction processing system.

25. A computer program product comprising a computer readable storage medium having computer readable program code embodied therewith, the computer readable program code comprising:
computer readable program code configured to issue one or more queries from a first node to one or more partner nodes within a multi-leg transaction processing system;
the one or more queries being configured to ascertain if the one or more partner nodes can process one or more transactions corresponding to the one or more queries; and
the one or more queries being further configured to enable the one or more partner nodes to generate an indication of one or more available transactions at the first node.
